(19) United States
(12) Patent Application Publication
(10) Pub. No.: US 2014/0069664 A1
(43) Pub. Date: Mar. 13, 2014

(54) Fire blue dot

(71) Applicant: Hemraj Chauhan, Camarillo, CA (US)

(72) Inventor: Hemraj Chauhan, Camarillo, CA (US)

(21) Appl. No.: 13/573,397

(22) Filed: Sep. 12, 2012

(51) Int. Cl. A62C 3/00; A62C 37/12

(52) U.S. Cl. 169/46; 169/57

(57) ABSTRACT

This invention is a novel apparatus and method for controlling and releasing a fire-resistant chemical material that will protect the cargo in an associated shipping container as well as extinguishing the fire within the container or pallet. The invention is a self-extinguishing delivery system that is easily installed in existing air cargo containers, pallets and nets.

### PRIORITY CLAIM

This patent application claims priority of my prior copending application Ser. No. 12/074,678 filed Mar. 4, 2008, which was entitled “Aerial Delivery of Fire Suppressant Material Upon a Cargo Within a Cargo Container”.

A video made at my facility, Aerofil, Inc., in late 2007, showed that after the specially manufactured plastic boards carrying the pouches of fire-suppressant agent were attached under the ceiling of the ULD container, a hot fire was then started in the lower part of the container. When the ULD interior temperature reached about 223 degrees Fahrenheit the plastic pouches began to disintegrate, releasing the powder to fall down toward the fire source. After a few seconds the fire was totally suppressed and the ULD interior temperature returned to ambient temperature, which was then 85 degrees Fahrenheit. The tests were a total success.

The present application discloses an improvement, namely, a fire retardant panel assembly. I prefer to call it by the business name or trademark as Fire Blue Dot.

### BACKGROUND OF THE INVENTION

In the transportation industry it has long been known to use pallets and containers for shipping various kinds of cargo. It has also been well known to employ a cargo net for surrounding and containing a loaded pallet, and then employ an overhead crane or fork lift to lift the net and load the pallet and cargo onto an aircraft, ship, or other transport vehicle.

Fire protection is a major concern in the shipment of commercial cargo. Fire-resistant pallets are extensively used. It is also known to employ fire-resistant blankets to place around or over the cargo pallet or container. The fire-resistant material in either a pallet or a blanket includes a chemical that will absorb heat as the ambient temperature rises, but without bursting into flame.

Thousands of pallets and containers are used every day on civil and military aircraft, and fire protection is a major concern. Currently there is no legislation to screen every piece of air cargo, and a 100 percent mandated screening would impose time and economic disruption on commercial and just-in-time shipping. Origination of fire from an undeclared source or sabotage is a threat to airliners and air cargo operations. There is therefore a great need in the air cargo industry to have a simple and effective fire prevention and delivery system.

### SUMMARY OF THE INVENTION

According to my invention I employ a novel method for controllably releasing a fire-resistant chemical material that will protect the cargo in an associated shipping container from actual fire spreading to outside the container as well as extinguishing the fire within the container or pallet. The invention is a self-extinguishing delivery system that is easily installed in existing air cargo containers, pallets and nets.

I select a chemical material which is initially in a solid physical state. This chemical material is placed in a series of plastic sheet pouches, each supported from a sheet or panel of rigid plastic material suspended from the ceiling or top of the shipping container which is to be protected. When there is an actual or potential fire, and the ambient temperature reaches a predetermined level, the plastic sheet material of some of the plastic pouches will melt thus allowing the solid state fire-resistant material to be released directly over the burning contents of the shipping container, dousing the fire.

The contents of the solid state chemical will preferably include four parts by volume of mono ammonium phosphate, plus one part by volume of ten to twenty-five percent ultramarine blue pigment blue 29, seventy-five to ninety percent calcium chloride, and 0.01 to 1.5 percent silica-crystalline quartz. These ingredients are first mixed together and assembled in the pouches and placed on the associated sheet or panel of rigid plastic material which is then attached to the ceiling or top of the shipping container itself.

According to the presently preferred form of my invention I manufacture a fire resistant panel assembly which may be used with any type of cargo or container. A moderately large plastic panel or board supports a number of separate mounds of fire-resistant powder, in rather widely separated locations. Suction holes are provided in the board or panel between the powder mound locations. A thin sheet of plastic is laid over the entire board or panel including all of the mounds of powder. This forms a special type of sandwich for further processing.

For further processing the sandwich thus prepared is placed in a commercial heat and pressure machine such as one that is commercially available under the name Ampak. Heat is applied to melt the thin plastic sheet while pressure is applied above the sheet to force the sheet down upon the powder mounds; and at the same time vacuum is applied underneath the board or panel to suck the thin sheet down tightly against it. As a result, depressed portions of the thin sheet become glued to the spaces between the powder mounds, thus forming separate pouches of powder, each covered by a thin sheet of the easily meltable plastic material.

The thus prepared sandwich may then be turned upside down and be secured under the ceiling of an aircraft ULD, so that an actual or incipient fire will cause the thin plastic sheet to rupture, allowing the fire-resistant powder to drip downwardly. The sandwich may also be attached upon the top of a container of some other type.

The system will provide a minimum of 120 minutes of fire suppressant capability and an additional 120 minutes of protection in case of re-ignition. The standard system activation is set at pre-determined 223 degrees Fahrenheit, but other settings can also be made.

The triggering temperature can also be set for any temperature above 120 degrees F., by appropriate selection of the material of the plastic pouches.

An important feature of the process is that the fire resistant panel assemblies which hold the fire extinguishing agent are made in advance as a separate manufacturing operation, and are therefore ready for rapid installation.

The sandwich may be installed to the ceiling of a ULD by means of support screws, or adhesively. The installation is very quick and easy.

My invention is a significant advance because the ingredients and their ratios of the chemical mix for the fire-suppressant powder were found from experimentation to be critical to the success of the process.

### DRAWING SUMMARY AND DETAILED DESCRIPTION

FIG. 1 is a plan view of a flat plastic panel or board 1, which is rectangular in shape and has screw holes 2 in its four corners for attachment to a shipping container. Border areas are designated by numeral 3. Inside the border there are twelve separated and discrete spaces 4 for placement of mounds of fire-retardant powder. Areas in between the powder locations 4 have a considerable number of small holes all the way through the material of board or panel 1, but not readily visible in FIG. 1.

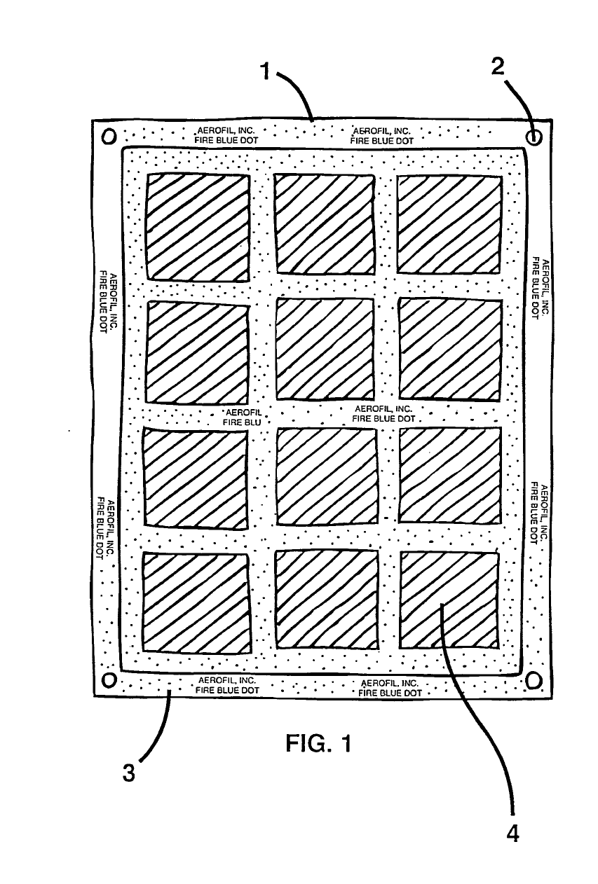

FIG. 2 is a photograph of a worker placing mounds 5 of fire-resistant powder on the discrete spaces 4. He is using a simple hand tool 6 for that purpose.

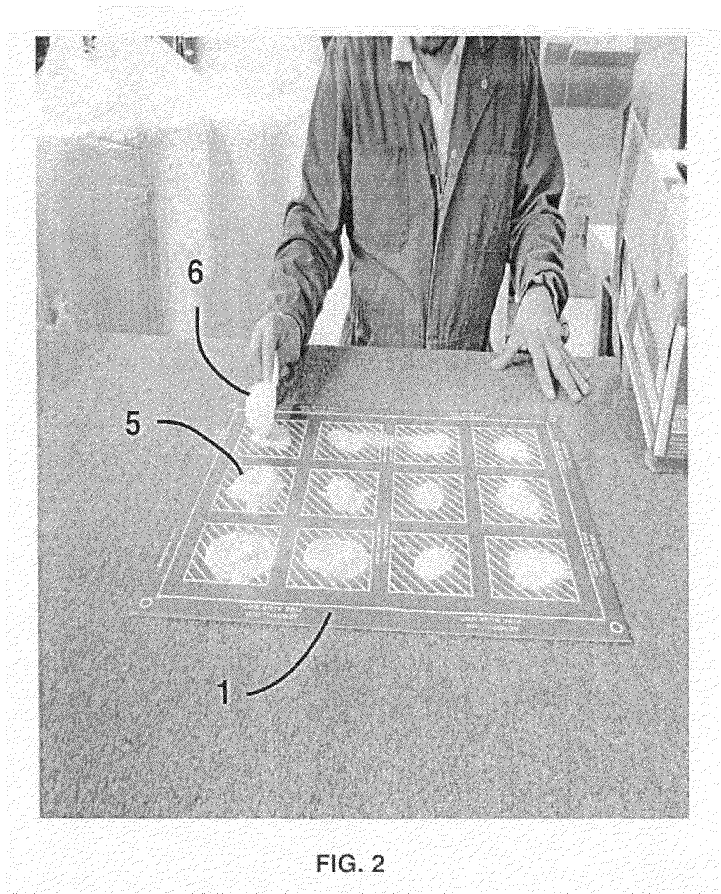

FIG. 3 is a photograph of an Ampak press and packaging machine 7 with a large roll of plastic material 8 moved off to the side. Numeral 9 identifies a control box for controlling operation of the Ampak machine. Numeral 10 identifies a pressure plate which can be forced downward for compressing an object or workpiece placed on the the work table of the Ampak.

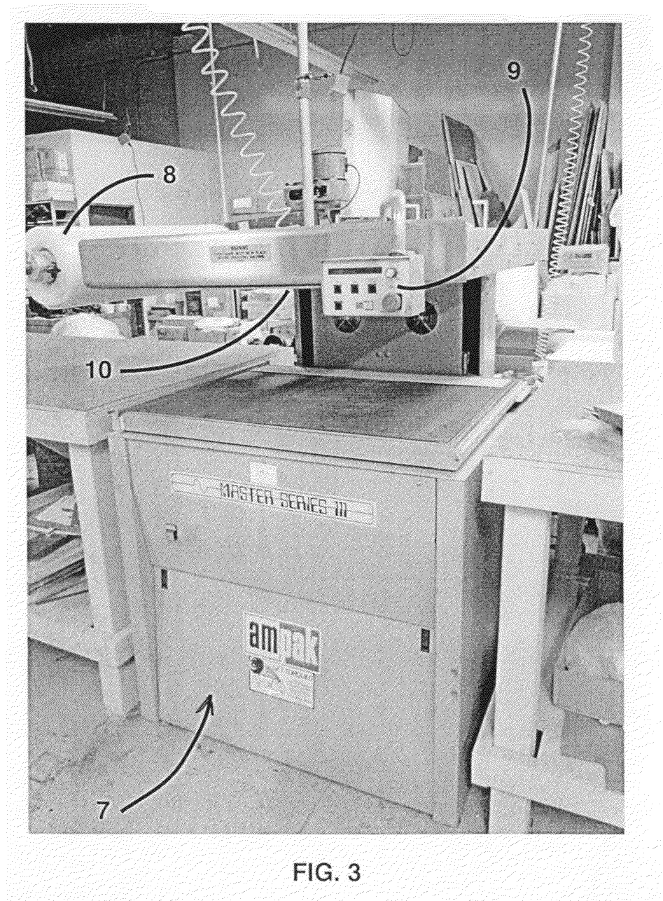

FIG. 4 is another photograph of the Ampak 7 showing sheet roll 8 suspended above the work table prior to dispensing a sheet of the material.

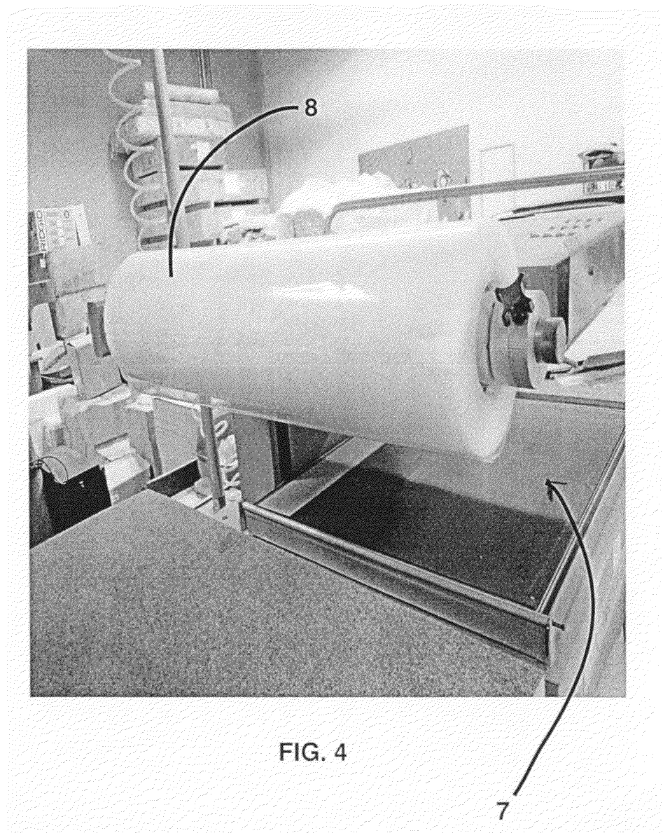

In the manufacturing process the mounds of powder 5 shown in FIG. 2 will be covered by a layer 18 of the thin sheet material from roll 8. They will thus be covered over, forming pouches which will then be identified as numeral 15. That completes the assembly of the production sandwich, then compressed and cooked in the Ampak.

FIG. 5 is a photograph showing the production sandwich in place on the work table of the Ampak, immediately after a sheet 18 of material from roll 8 has been placed over the board or panel 1. Pouches 15 are on the upper surface of panel 1. Behind the work table an electric heater 17, a part of the Ampak machine, is turned on to melt the plastic sheet material 18, which forms pouches 15 and covers spaces between them.

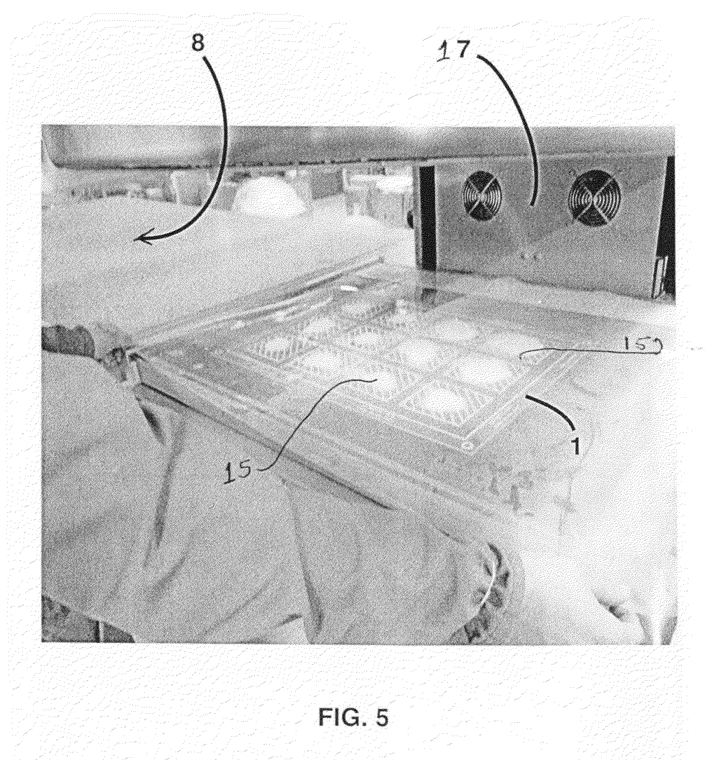

FIG. 6 is an artistic sketch indicating the operation that is accomplished in the Ampak machine 7. Numeral 11 indicates heat being applied to the package that now includes panel 1, pouches 15, and a layer 18 of sheet material. At the same time, the pressure plate 10 is forced downward, as shown by arrows 14. Numeral 12 indicates vacuum applied to the under side of the plastic board or panel 1.

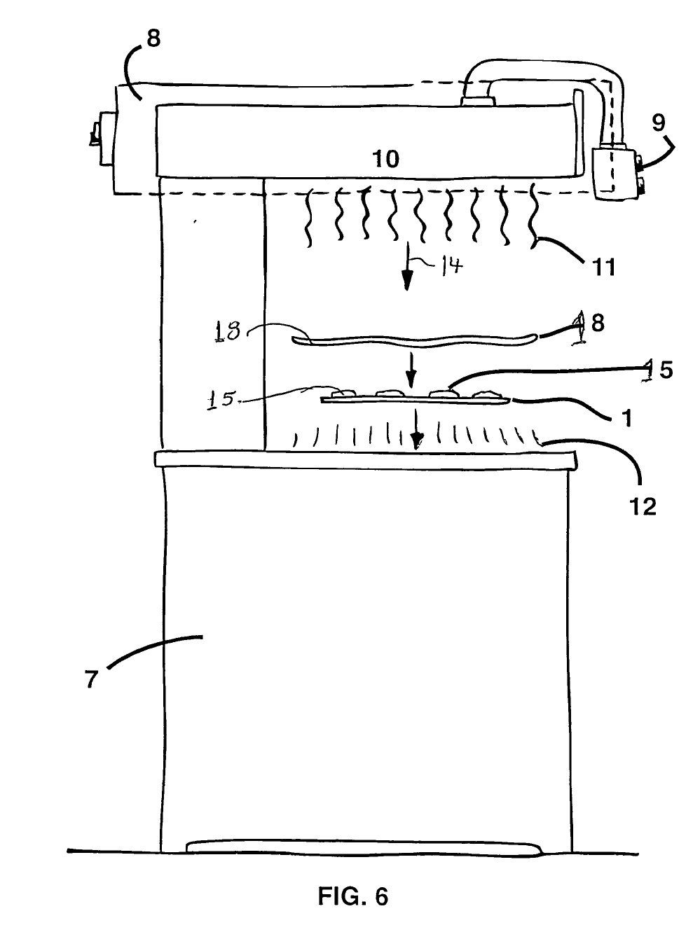

FIG. 7 is an illustration of an enlarged vertical cross-section of a small portion of the production package. Pouches 15 are covered by the thin sheet layer 18. Because of the enlargement, numerous holes 13 through the panel 1 are clearly visible. The illustration also indicates that suction has been applied beneath the worktable, with the result that sheet portions 20 between the pouches 15 are now depressed in the areas between spaces 4. In fact, the combined effects of heat, downward pressure, and vacuum from below, are sufficient to cause the sheet portions 20 to become firmly glued to the upper surface of board or panel 1.

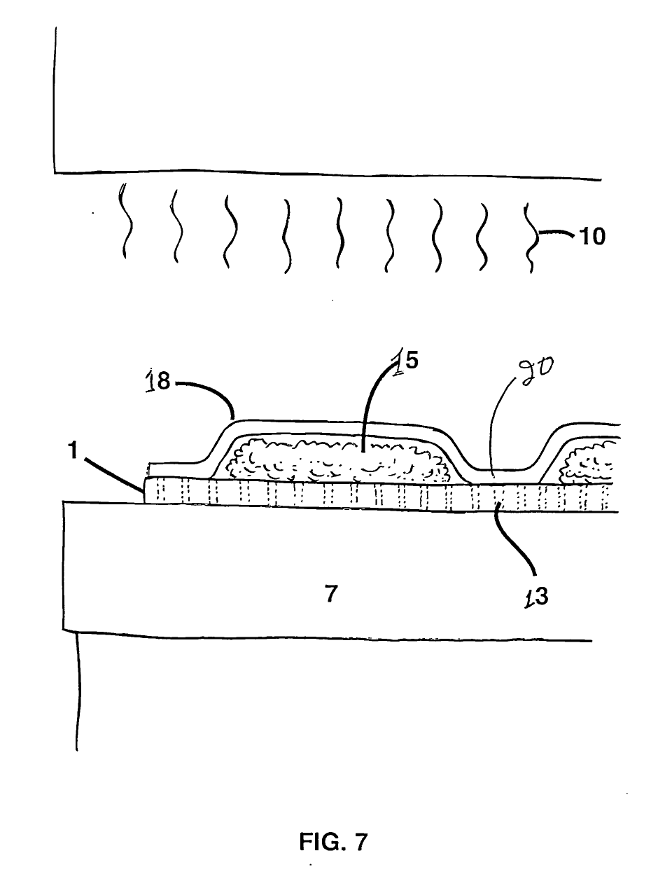

FIG. 8 is an outline drawing of a typical ULD 25 used for transporting cargo by aircraft. An arrow 23 indicates where the fire resistant panel package will be placed against the ceiling of the ULD.

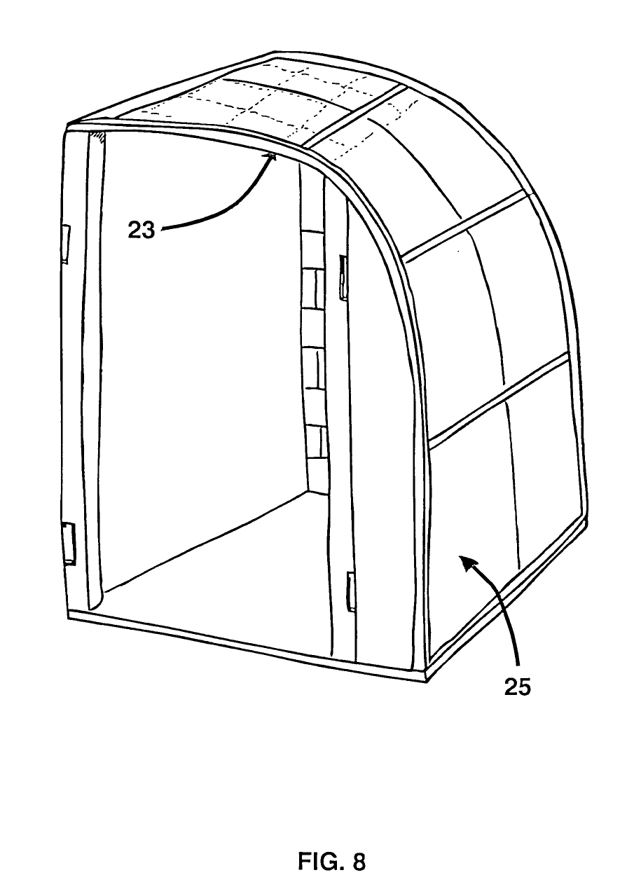

FIG. 9 is a photograph of a man securing a completed panel inside the ULD. The panel is forced against the ceiling of the ULD and secured by screws at the corners.

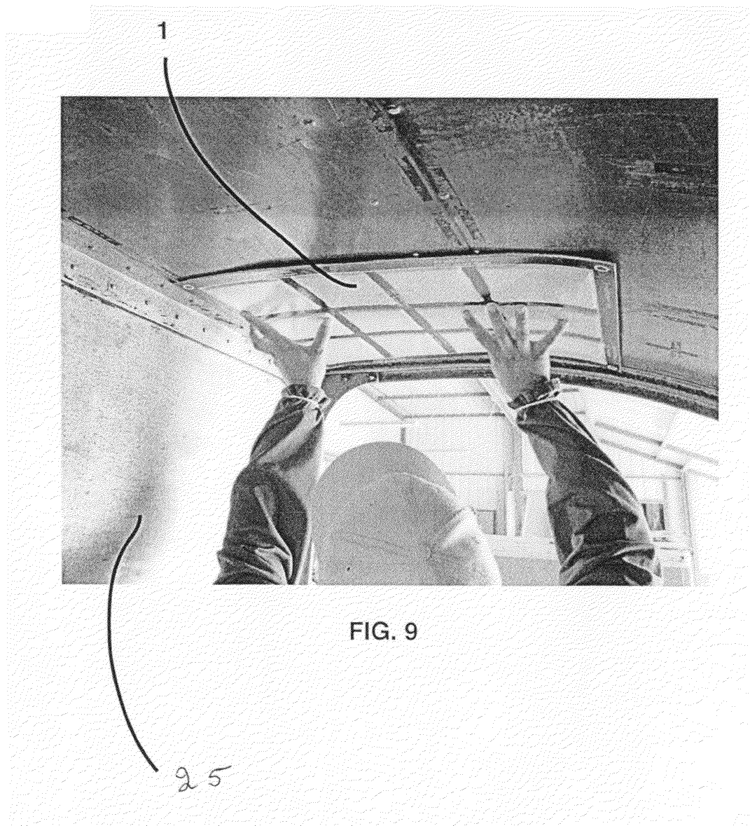

FIG. 10 shows the fire resistant panel assembly in operation when there is an actual or incipient fire. Elevated ambient temperature has caused the plastic sheet 18 covering pouches 15 to rupture, thus allowing powder modules 35 to drip downward toward cargo C.

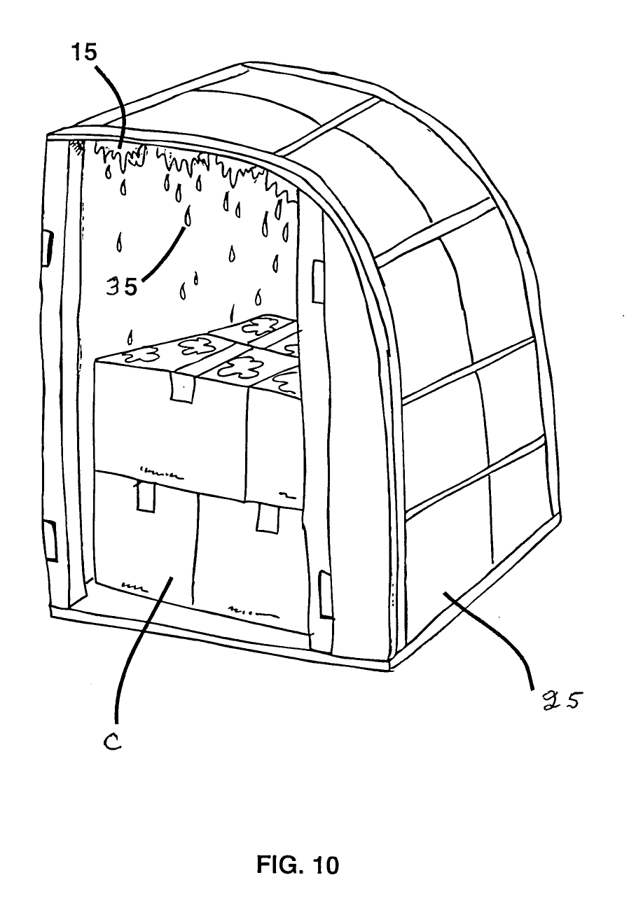

What I claim is:

1. A Fire Retardant Panel Assembly comprising, in combination:
(a) a relatively large flat plastic board having a back surface and a front surface;
(b) a plurality of mounds of fire retardant chemical powder in widely separated locations on the front surface of the plastic board;
(c) a thin sheet of plastic material covering the front surface of the board and the mounds of powder and being depressed downwardly against the board in areas between the mounds of powder, thus forming discrete chemical powder pouches in spaced and separated locations, securing the mounds of powder in their places, and being glued to the front surface of the board at locations intermediate to the mounds of chemical powder;
(d) the melting temperature of the plastic board being significantly higher than that of the thin plastic sheet;
(e) the board having numerous openings extending therethrough from its back to front at those intermediate locations; and
(f) the assembly being adapted to be secured to a shipping container with its front surface down so that when heat is applied to its then downwardly extending front surface, the thin plastic sheet will rupture at the powder locations to release powder to drop down.

2. The method of aerial delivery of a self-extinguishing fire-suppressant material to a cargo being transported within a unit load device, comprising the steps of:
[a] selecting a ULD having a top wall, and a bottom;
[b] placing a cargo in supporting relation on the bottom of the ULD;
[c] selecting a dry powdered fire suppressant chemical material which is a mixture of about five parts by volume, in which four parts are mono ammonium phosphate; and one part is ten to twenty-five percent ultramarine blue-pigment 29, seventy-five to ninety percent calcium chloride, and 0.01 to 1.5 percent silica;
[d] selecting a rigid plastic panel which will not melt at 223 degrees Fahrenheit, and having on one surface spaces for mounds of powder;
[e] placing the powder in mounds on those spaces;
[d] selecting a sheet of plastic material adapted to commence melting when exposed to a temperature level of about 223 degrees Fahrenheit, and placing it over the mounds of powder;
(e) subjecting the thus-created assembly of panel, powder mounds, and plastic sheet, to heat and pressure to shrink the sheet of plastic around the powder mounds; and
[h] then placing the panel assembly beneath the top of the ULD with the powder mounds disposed downwardly, and securing it to there so that the fire-suppressant chemical material when exposed to a temperature of about 223 degrees will absorb heat without bursting into flame, and the plastic sheet will then commence melting and drop the fire-suppressant material onto the load below.
